(19) United States
(12) Patent Application Publication
(10) Pub. No.: US 2009/0024240 A1
(43) Pub. Date: Jan. 22, 2009

(54) Workstation display for an assembly location having a timing indicator portion

(75) Inventors: Lawrence W. Clark, Morton, IL (US); Gary Champion, Chillicothe, IL (US); Mitchell Radebaugh, Mapleton, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/879,255

(22) Filed: Jul. 17, 2007

(51) Int. Cl. G06F 19/00

(52) U.S. Cl. 700/111

(57) ABSTRACT

An assembly line includes a plurality of assembly locations. One of a plurality of sequential assembly tasks is performed at each assembly location. A workstation, located at each assembly location, is configured to display information regarding one of a number of variations of the one assembly task to be performed. A timing device is provided for determining a start time of the one assembly task. A display of the workstation includes a timing indicator portion configured to change color in response to a predetermined lapse of time relative to the start time.

### TECHNICAL FIELD

The present disclosure relates generally to an assembly line having a workstation located at each assembly location, and more particularly to a timing indicator portion of the workstation configured to change color in response to a lapse of time.

### BACKGROUND

Assembly lines generally include a plurality of assembly locations at which sequential assembly tasks are performed. Each assembly location typically includes a work area at which an assembly technician performs a task, such as, for example, the integration or assembly of components of a product. The assembly technician is generally provided with a set of assembly instructions and any additional documentation deemed essential to the assembly operation.

Increasingly, manufacturing facilities, such as assembly lines, are providing the necessary documentation electronically, via computer workstations located throughout the facility. In some implementations, computer workstations are provided at each assembly location and, therefore, greatly reduce the amount of paper documentation that may accumulate at each work area. By providing current and consistent documentation at convenient locations, the computer workstations may contribute to improved efficiency of each assembly technician and the manufacturing process in general. This is especially true in sophisticated assembly operations where assembly instructions for several variations of an assembly task are necessary at each assembly location.

For individual performance evaluation, however, most manufacturing facilities provide only a universal clock or marquee, indicative of goals and performance for the entire facility. For example, a marquee may provide the production goal and the current production count for a particular shift. An assembly technician, however, may be unable to determine individual performance relative to plan allocated assembly times. One individual performance indicator is provided in U.S. Pat. No. 5,212,635. Specifically, a graphic representation, such as an hourglass, is provided on a visual display for displaying the amount of elapsed time since initiation of a selected operation and the amount of time remaining within a specified period of time. This graphic representation, however, does not provide a clear indication of a specific lapse of time that is easily visible both inside and outside of the respective assembly location. In addition, when the assembly technician comes to memorize assembly instructions that remain the same for each assembly task being performed, there is little reason to continuously reference the visual display.

The present disclosure is directed to one or more of the problems set forth above.

### SUMMARY OF THE DISCLOSURE

In one aspect, an assembly line includes a plurality of assembly locations. One of a plurality of sequential assembly tasks is performed at each assembly location. A workstation, located at each assembly location, is configured to display information regarding one of a number of variations of the one assembly task to be performed. A timing device is provided for determining a start time of the one assembly task. A display of the workstation includes a timing indicator portion configured to change color in response to a predetermined lapse of time relative to the start time.

In another aspect, a method of operating an assembly line includes a step of performing one of a plurality of sequential assembly tasks at one of a plurality of assembly locations. Information regarding one of a number of variations of the one assembly task is displayed on a workstation display located at the assembly location. The method also includes a step of determining a start time of the assembly task. A color of a timing indicator portion of the display is changed in response to a predetermined lapse of a plan allocated time relative to the start time.

In yet another aspect, a timing indicator located at an assembly location of an assembly line includes a workstation having a display configured to display information regarding one of a number of an assembly tasks to be performed at the assembly location. A timing device determines a start time of the one assembly task. A timing indicator portion of the display is configured to change color in response to a predetermined lapse of time relative to the start time.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a simplified schematic view of an assembly line according to the present disclosure;

FIG. 2 is a first illustration of a workstation display of the assembly line of FIG. 1;

FIG. 3 is a second illustration of the workstation display of FIG. 2;

FIG. 4 is a third illustration of the workstation display of FIG. 2; and

FIG. 5 is a flow chart of one embodiment of a method for operating an assembly line according to the present disclosure.

### DETAILED DESCRIPTION

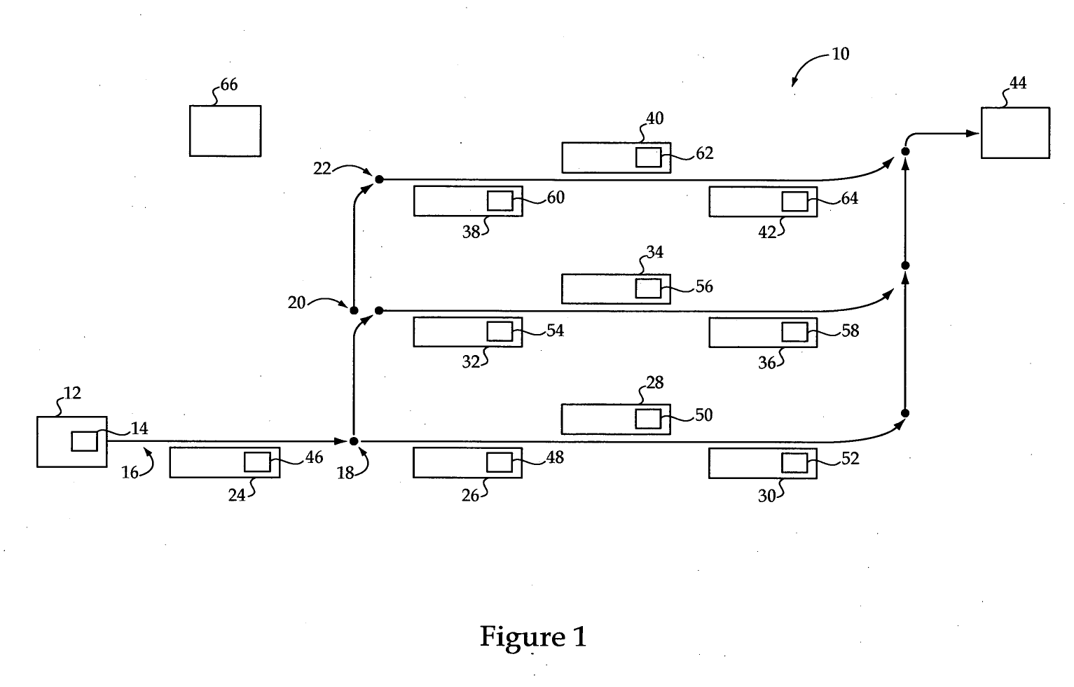

An exemplary embodiment of an assembly line 10 is shown generally in FIG. 1. The assembly line 10 is well known in the art and generally includes a mechanism for moving a product among a plurality of assembly locations at which various sequential tasks, such as assembly tasks, are performed. A loading area 12 may be provided for loading a product 14, such as, for example, an engine or partially assembled machine, onto the conveyance means. The product 14 may be loaded on a conveyor system, such as a common belt conveyor system, or, alternatively, the product 14 may be hung on a trolley system. Trolley systems are also well known and generally include a trolley that is movable along an overhead rail.

Assembly line 10 may be designed and installed for the manufacture of similar products or, alternatively, for the manufacture of a variety of different types and configurations of products. Assembly line 10 will generally include a plurality of lines along which the product 14 is routed in order to perform differing assembly tasks. All products may be routed along some lines, while only some products may be routed along other lines. Specifically, the product 14, and all other products manufactured by assembly line 10, may be movable along a first line 16. The product 14 may then be routed along one of a second line 18, a third line 20, and a fourth line 22. Lines 18, 20, and 22 may all include similar tasks or, alternatively, may include differing tasks, depending on the design of the assembly line 10. For example, assembly line 10 may manufacture truck engines, marine engines, and various other types and configurations of engines that all require differing assembly tasks.

Line 16 may include an assembly location 24. It should be appreciated that assembly location 24 includes a work area at which an assembly technician performs one of a plurality of sequential assembly tasks on product 14. Assembly location 24 may also include any tools and/or documentation, such as assembly instructions, pertinent to the assembly task. If multiple tasks are performed at assembly location 24, it may be necessary to provide assembly instructions for each of the assembly tasks to be performed. Additionally, if assembly line 10 manufactures different types of products, such as engines, it may be necessary to provide assembly location 24 with assembly instructions for similar tasks that are performed on different engine types. For example, a marine engine may have different and/or extra components relative to a counterpart truck version of the same engine. It may, therefore, be necessary to provide assembly instructions for an assembly task to be performed on the marine engine and differing assembly instructions for the same assembly task that is to be performed on the truck engine.

The second line 18 includes assembly locations 26, 28, and 30, while the third line 20 and the fourth line 22 similarly include assembly locations 32, 34, and 36, and assembly locations 38, 40, and 42, respectively. After the final assembly task is performed on product 14, it will be routed to an offloading area 44. The product 14 may then be removed from the conveyor system or offloaded from the trolley system. Although only a limited number of lines, 16, 18, 20, and 22, and assembly locations, 24-42, are shown, it should be appreciated that assembly line 10 will typically include numerous lines and numerous assembly locations, often of complex arrangements.

The documentation provided at each assembly location, such as, for example, assembly location 24, may be provided via a workstation, such as a computer workstation 46. One or more computer workstations may be provided throughout the assembly line 10 to help reduce the large amounts of paper documentation that are disseminated throughout the assembly line 10. Specifically, all assembly locations 26-42 of the assembly line 10 may include computer workstations 48-64, respectively. It may be desirable to position each of the computer workstations 46-64 so that they may be viewed from outside the respective assembly locations 44-42. For example, it may be desirable to position the computer workstations 46-64 so that the displays of the computer workstations 46-64 may be viewed simultaneously by a supervisor of the assembly line 10.

The computer workstations 46-64 may be in network communication, via a wired and/or wireless connection, with a master workstation 66. The master workstation 66 may be configured to instruct the workstations 46-64 located at assembly locations 24-42 to display information, such as assembly instructions, regarding assembly tasks to be performed. Therefore, rather than sending paper documentation to each of the assembly locations 24-42, the same documentation may be transferred electronically from the master workstation 66 to each of the computer workstations 46-64.

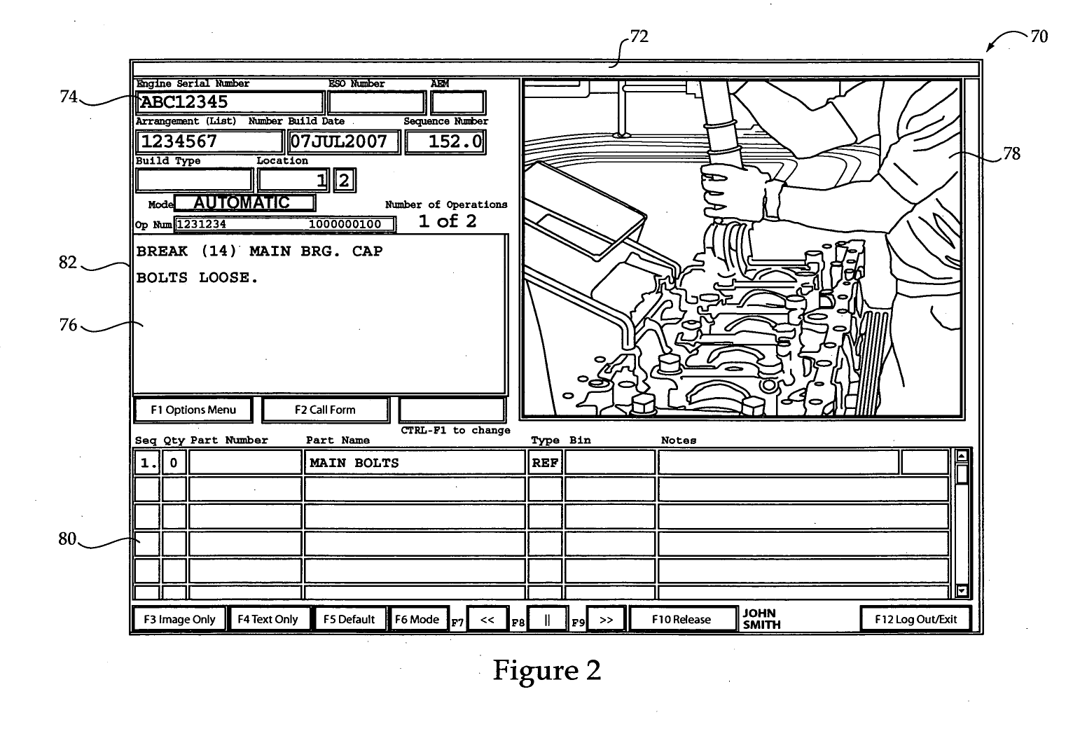

Each of the computer workstations 46-64 is well known in both function and form, and includes a display 70, as illustrated in FIG. 2. By way of example, the display 70 may be the display of computer workstation 46. The display 70 may be configured to display information regarding the assembly tasks to be performed at assembly location 24. Specifically, a number of variations of assembly instructions for each of the assembly tasks to be performed at assembly location 24 may be conveyed through display 70. The display 70 may be configured to display one of numerous screens of a software application, such as a screen 72 of a software application supporting a paperless factory.

The screen 72 may be interactive and may display various information associated with an assembly task, or the assembly operation in general. Regarding an assembly task to be performed on product 14, the screen 72 may include an identifying information portion 74 that includes specific information about the product 14. For example, in the manufacture of engines, the assembly line 10 may produce various types of engines and/or similar engines having different configurations. Specifically, truck engines, marine engines, and various other types and configurations of engines may be manufactured. Therefore, it may be desirable to provide information regarding the specific type and configuration of engine on the identifying information portion 74 of screen 72.

The screen 72 may also include an instruction portion 76 that includes information regarding the assembly task to be performed on product 14. The master workstation 66 may be in communication with product 14 or the conveyance means thereof to determine the specific type of product 14. In response, the master workstation 66 may instruct the computer workstation 46 or, more specifically, the instruction portion 76 of display 70 to display the appropriate assembly instructions for the established product type. Alternatively, the computer workstation 46 may be in communication with product 14 or the conveyance means thereof to determine the appropriate assembly instructions to display.

Continuing with the example of an engine manufacturing facility, the instruction portion 76 may display instructions for an assembly task that pertain to the specific type and configuration of engine currently at assembly location 24. Specifically, if an assembly task of securing a crankshaft to an engine is performed at assembly location 24, it should be appreciated that the assembly instructions for this task may vary based upon specific engine types, such as, for example, truck engines or marine engines. It should also be appreciated that assembly instructions may vary for truck engines having different configurations. For example, one truck engine may require that the crankshaft be mounted at a first end thereof, while a truck engine of a different configuration may require that the crankshaft be mounted at a second end thereof.

One or more images may be provided on an image portion 78 of the screen 72 to supplement the written assembly instructions of the instruction portion 76. For example, an image of a relevant portion of product 14 having the specific assembly task already performed may be displayed on image portion 78. A listing of tasks portion 80 may also be provided, if the assembly task consists of multiple steps. Although specific examples of information that may be displayed by screen 72 are given, it should be appreciated that any desired information may be displayed.

In order to track the efficiency of the assembly technicians at each of the assembly locations 24-42, the computer workstations 46-64 may be configured to record the time spent performing each assembly task. This assembly time, or process time, may be ascertained through a paperless factory software application, or by any other well known means. Typically, a start time is captured when an assembly task is initiated. For example, an assembly task at assembly location 24 may be initiated manually through the computer workstation 46, or automatically, such as when the product 14 is removed from the conveyor or trolley system. When the assembly task is initiated, a timing device of the computer workstation 46 may create a timestamp, i.e., record a current time of the computer workstation or, alternatively, a current time of a master clock, such as a clock of the master workstation 66.

The assembly time will continue to increment until the assembly task is completed. The assembly task may be deemed completed when the assembly technician manually stops the assembly time through the computer workstation 46 or, alternatively, when the product 14 is returned to the conveyor or trolley system. This assembly task time may be stored locally in the computer workstation 46 and/or in the master workstation 66.

Plan allocated times, as determined by a production plan for the assembly line 10, may represent times allowed for specific assembly tasks. Plan allocated times are selected in order to meet manufacturing goals of the assembly line 10 and may differ, depending on the assembly task and/or the engine type. Assembly task times or, more specifically, the actual time taken to perform a task may ultimately be compared to the plan allocated time for the task in order to determine the efficiency of the assembly technician and/or adjust the plan allocated time to more accurately reflect a reasonable assembly time. In fact, it is common practice to compare the assembly task times to their respective plan allocated times for all assembly technicians for a specified period of time to determine the overall efficiency of the assembly line 10. Specifically, each of the computer workstations 46-64 and/or the master workstation 66 may be configured to compile data relative to the difference between the plan allocated time and the actual process time for each assembly task to determine the overall efficiency of assembly line 10.

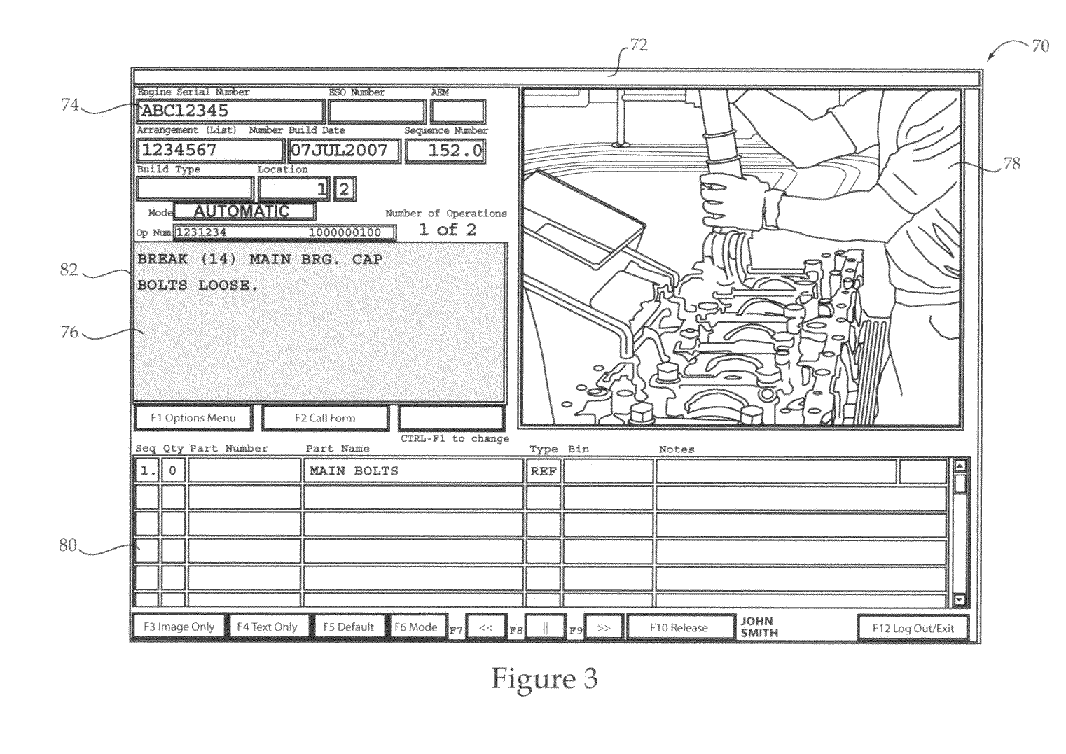

Turning now to FIG. 3, the instruction portion 76 or, more specifically, a background color of the instruction portion 76 may change from a white or opaque color, as shown in FIG. 2, to a yellow color, upon the lapse of a predetermined portion of the plan allocated time. It may be desirable to change to a yellow color when a percentage, such as, for example 70% or 80%, of the plan allocated time has elapsed. It should be appreciated that a color change may be effected when any percentage of the plan allocated time has elapsed.

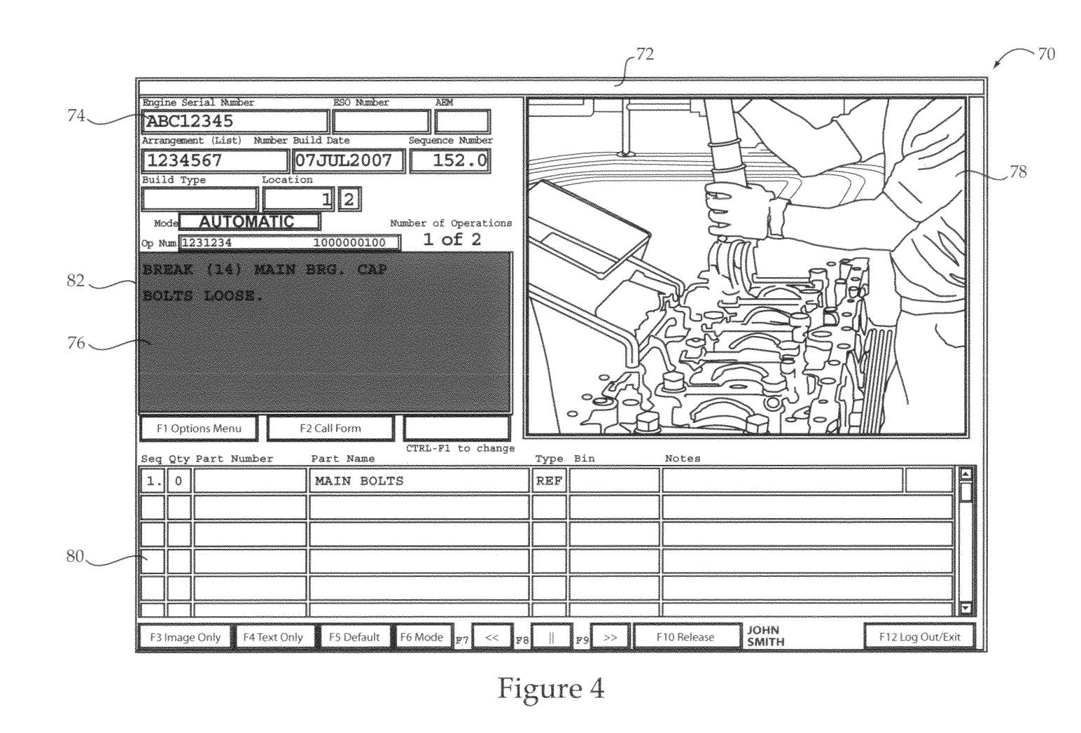

Turning now to FIG. 4, the instruction portion 76, also referred to as a timing indicator portion 82, may change from the yellow color, as shown in FIG. 3, to a red color upon the lapse of the plan allocated time. Again, the color may be changed when any desired percentage of the plan allocated time has elapsed. In addition, the colors of yellow and red have been selected because of their common associations with “caution” and “stop.” However, it should be appreciated that any colors may be used.

### INDUSTRIAL APPLICABILITY

Referring to FIGS. 1-5, an exemplary embodiment of an assembly line 10 is shown generally in FIG. 1. Assembly line 10 includes a plurality of lines, such as lines 16, 18, 20, and 22, along which a product 14 is routed in order to perform differing assembly tasks. Each of the lines 16, 18, 20, and 22 may include assembly locations, such as assembly location 24. It should be appreciated that assembly location 24 includes a work area at which an assembly technician performs one of a plurality of sequential assembly tasks on product 14. Assembly location 24 also includes a computer workstation 46 for providing documentation pertinent to the assembly process. Specifically, the computer workstation 46 may include a display 70 configured to display one of numerous screens of a software application. The software application may include any application for managing manufacturing operations.

It may be desirable to provide an indication of elapsed time relative to a start time for each assembly technician. Typically, a universal clock or marquee is provided that indicates goals and performance for the entire facility. However, each assembly technician is often evaluated based on individual performance, such as, for example, the time taken to perform an assembly task. While these times are often recorded and compared to plan allocated times, such as TAKT times implemented by the well known Six Sigma methodology, each assembly technician is not given real time indications of individual performance.

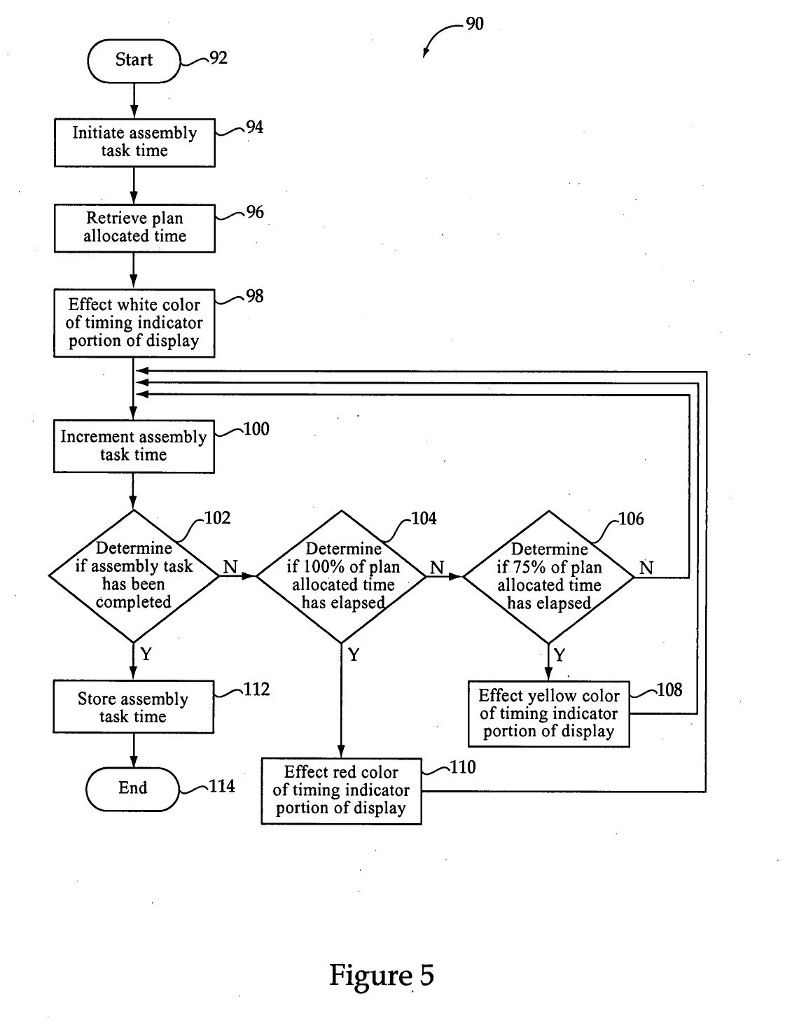

The assembly line 10 and method of the present disclosure provide a clear indication of a specific lapse of time, such as a plan allocated time, via the computer workstations located at each assembly location. An exemplary workstation includes computer workstation 46, having a display 70, located at assembly location 24. Turning to FIG. 5, there is shown a flow chart 90 representing an exemplary method of operating the assembly line 10 of FIG. 1. The method begins at a START, Box 92. From Box 92, the method proceeds to Box 94, which includes the step of initiating an assembly task time. An assembly task time at assembly location 24 may be initiated manually via the computer workstation 46, or automatically, such as when the product 14 is removed from the conveyor or trolley system. The start time may, for example, include a timestamp captured and recorded at computer workstation 46 or, alternatively, master workstation 66.

From Box 94, the method proceeds to Box 96. At Box 96, the plan allocated time is retrieved. The plan allocated time may include any optimal time given for the specific assembly task to be performed and may be provided by a production plan for the assembly line 10. The method then proceeds to Box 98, which includes the step of effecting a white color of the timing indicator portion 82 of the display 70. Although white is given as an example, it should be appreciated that any color may be selected as an initial color of the timing indicator portion 82. In addition, it should be appreciated that, although the timing indicator portion 82 includes the instruction portion 76, the timing indicator portion 82 may be positioned on any portion of a display located on or near the computer workstation 46. If a number of variations of assembly tasks are performed at assembly location 24 and it is, therefore, necessary to view the instruction portion 76 throughout each assembly task, it may be desirable to include the timing indicator portion 82 within the instruction portion 76.

After the timing indicator portion 82 of the display has been changed to a white color, the method proceeds to Box 100, which includes the step of incrementing the assembly task time. At Box 102, the method determines it the assembly task has been completed. The assembly task may be deemed completed when the assembly technician manually stops the assembly time via the computer workstation 46 or, alternatively, when the product 14 is returned to the conveyor or trolley system.

If the assembly task has not been completed, the method proceeds to Box 104. At Box 104, the method determines if the plan allocated time has elapsed. This can be determined by comparing the time that has elapsed from the start time to the plan allocated time. If the plan allocated time has not elapsed, the method proceeds to Box 106, where the method determines if a percentage, such as, for example, 75% of the plan allocated time has elapsed. It should be appreciated that a simple algorithm may be implemented by a processor of the computer workstation 46 to determine if a specific percentage of the plan allocated time has elapsed relative to the start time. If 75%, or other predetermined percentage, of the plan allocated time has not elapsed, the method returns to Box 100 where the assembly task time is incremented and the same queries are repeated.

If, however, at Box 106, the method determines that 75% of the plan allocated time has elapsed, the method effects a yellow color of the timing indicator portion 82 of the display 70. The method then returns to Box 100 where the assembly task time is incremented, since the assembly task is not yet completed. The timing indicator portion 82 will remain yellow and the assembly task time will continually increment until, at Box 104, the method determines that 100% of the plan allocated time has elapsed. If 100% of the plan allocated time has elapsed, the method effects a red color of the timing indicator portion 82 of the display 70, at Box 110. After the timing indicator portion 82 has changed to a red color, the method will continue incrementing the assembly task time until the method determines, at Box 102, that the assembly task is completed.

After the assembly task is completed, the method continues to Box 112, which includes the step of storing the assembly task time. Assembly task times or, more specifically, the actual time taken to perform a task may ultimately be compared to the plan allocated time for the task in order to determine the efficiency of the assembly technician or whether the plan allocated time needs adjustment, or both. Additionally, the assembly task times for assembly tasks performed by all assembly technicians may be compared to the respective plan allocated times over a specific period of time to evaluate overall efficiency of the assembly line 10. From Box 112, the method proceeds to an END, at Box 114. The timing indicator portion 82 of the display 70 may remain a red color until the method begins again with the initiation of another assembly task. Once a new assembly task is initiated, the timing indicator portion 82 may return to a white color, at Box 98.

It should be appreciated that the computer workstations 46-64 located at assembly locations 24-42, respectively, of the assembly line 10 may be positioned so that the displays of the computer workstations 46-64 may be viewed from outside the respective assembly locations 24-42. The time indicating color change can then be viewed by the assembly technicians and supervisors of the assembly line 10 who are located outside of the respective workstations. It should be appreciated that the computer workstations 46-64 and/or the master workstation 66 could be configured to effect a time indicating color change in stack lights, tower lights, or any other devices located at or near each of the assembly locations 24-42. However, because assembly instructions differ for the one or more assembly tasks performed at each assembly location, it may be useful to position the timing indicator portion 82 on or near the instruction portion 76 of the screen 72.

Implementation of the assembly line 10 and method of the present disclosure has been shown to significantly increase efficiency of assembly technicians and an assembly line in general. Specifically, a case study was conducted at an engine manufacturing facility using a baseline time period between May 1, 2006 and Jul. 23, 2006 and an observation time period, after implementation of the present method, between Jul. 24, 2006 and Sep. 22, 2006. During the baseline period, engine build was increasing by about 0.81 engines per day, whereas during the observation period engine build was increasing by about 1.46 engines per day. In addition, the study indicated that the actual cycle time, i.e., the time taken for performing an assembly task, decreased by about 0.122 seconds per day. It was also shown that the percentage of over cycles, i.e., instances in which the actual cycle time exceeds a plan allocated time, decreased, and the percentage of under cycles, i.e., instances in which the actual cycle time is less than a plan allocated time, increased.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An assembly line, comprising:
a plurality of assembly locations, wherein one of a plurality of sequential assembly tasks is performed at each assembly location;
a workstation located at each assembly location, wherein each workstation is configured to display information regarding one of a number of variations of the one assembly task to be performed;
a timing device located at each workstation for determining a start time of the one assembly task; and
a timing indicator portion of a display of the workstation, wherein the timing indicator portion is configured to change color in response to a predetermined lapse of time relative to the start time.

2. The assembly line of claim 1, further including a master workstation configured to instruct the workstation located at the assembly location to display information regarding a select one of the number of variations.

3. The assembly line of claim 1, wherein the workstation is further configured to display an assembly instruction on an instruction portion of the display for the one variation of the assembly task.

4. The assembly line of claim 3, wherein the workstation is further configured to display the assembly instruction on the timing indicator portion of the display.

5. The assembly line of claim 4, wherein all of the workstations are positioned to be viewed from at least one location outside the respective assembly locations.

6. The assembly line of claim 4, wherein the start time includes a current time received from a master clock.

7. The assembly line of claim 6, wherein the start time is determined from an operator input.

8. The assembly line of claim 6, wherein the start time is determined when a partially assembled machine arrives at the assembly location.

9. The assembly line of claim 6, wherein the predetermined lapse of time includes a plan allocated time.

10. The assembly line of claim 9, wherein the timing indicator portion is further configured to change color in response to a lapse of a portion of the plan allocated time relative to the start time.

11. The assembly line of claim 10, wherein the timing indicator portion is further configured to change to a yellow color in response to a lapse of a portion of the plan allocated time relative to the start time, and wherein the timing indicator portion is further configured to change to a red color in response to a lapse of the plan allocated time relative to the start time.

12. The assembly line of claim 10, wherein the timing device is configured to determine a stop time of the at least one assembly task, and wherein the workstation is further configured to record an actual process time based on the start time and the stop time.

13. The assembly line of claim 12, wherein the workstation is further configured to compile data relative to the difference between the plan allocated time and the actual process time for each of the plurality of assembly tasks.

14. A method of operating an assembly line, comprising:
performing one of a plurality of sequential assembly tasks at one of a plurality of assembly locations;
displaying information regarding one of a number of variations of the one assembly task on a workstation display located at the assembly location;
determining a start time of the assembly task; and
changing a color of a timing indicator portion of the display in response to a predetermined lapse of a plan allocated time relative to the start time.

15. The method of claim 14, wherein the displaying step includes displaying an assembly instruction on an instruction portion of the display.

16. The method of claim 14, wherein the displaying step includes displaying an assembly instruction of the timing indicator portion of the display.

17. The method of claim 16, wherein the changing step further includes changing a color of the timing indicator portion of the display to a second color in response to a lapse of a portion of the plan allocated time relative to the start time.

18. The method of claim 15, further including positioning all of the workstations to be viewed from at least one location outside the respective assembly locations.

19. The method of claim 14, further including communicating with a master workstation, and receiving a current time from a master clock.

20. A timing indicator located at an assembly location of an assembly line, comprising:
a workstation having a display configured to display information regarding one of a number of an assembly tasks to be performed at the assembly location;
a timing device for determining a start time of the one assembly task; and
a timing indicator portion of the display, wherein the timing indicator is configured to change color in response to a predetermined lapse of time relative to the start time.
